(19) United States
(12) Patent Application Publication
(10) Pub. No.: US 2010/0214480 A1
(43) Pub. Date: Aug. 26, 2010

(54) HDMI Device and Electronic Device

(75) Inventor: Yutaka KITAMORI, Osaka (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/708,796

(22) Filed: Feb. 19, 2010

(30) Foreign Application Priority Data
Feb. 19, 2009 (JP) 2009-036269

(51) Int. Cl. H04N 3/27

(52) U.S. Cl. 348/554; 348/E03.049

(57) ABSTRACT

An HDMI device includes a storing unit for storing signal-processing data relating to image and/or sound quality of the HDMI device, an information acquisition unit acquiring the signal-processing characteristic information of the another device connected by an HDMI connection, and a setting changing unit for changing the setting of signal-processing relating to the image and/or sound quality of the device based on the data stored in the storing unit and the data acquired by the information acquisition unit.

### CROSS REFERENCE TO RELATED APPLICATIONS

This application claims priority under 35 U.S.C. §119 to Japanese Pat. App. No. 2009-036269, filed Feb. 19, 2009, which is incorporated herein by reference in its entirety.

### BACKGROUND OF THE INVENTION

1. Field of the Invention

The instant disclosure relates to High-Definition Multimedia Interface (HDMI) devices and/or electronic devices including a HDMI standard. 2. Description of Related Art

HDMI is a digital audiovisual (AV) equipment-oriented digital interface that can achieve high-speed transmission of image or sound data using a single cable. In recent years digital AV equipment, such as flat panel TVs or DVD recorders have been produced with HDMI terminals preinstalled.

HDMI cable for connecting digital AV equipment having HDMI terminals generally has first to fifth signal wires.

The first signal wire is a Transition Minimized Differential Signaling (TMDS) data signal wire, which is a simplex line transmitting sound (audio) and image (visual) data (hereafter, called “AV data”) and info-frame (format of AV data, etc.) from a source device to a sync device in TMDS format.

The second signal wire is a Hot Plug Detect (HPD) signal wire that is primarily used to indicate when to start transmitting AV data from a source device to a sync device.

The third signal wire is a Display Data Channel (DDC) signal wire for transmitting information specific to a sync device (such as vendor name, model number, allowable resolution, and terminal number of HDMI) to a source device. Further, the DDC signal wire is also used for High-bandwidth Digital Content Protection (HDCP) authentication. The DDC signal wire is connected to Non Volatile RAM (NVRAM) installed in a sync device when the HDMI cable is connected to a HDMI terminal of a sync device.

The fourth signal wire is DDC 5V signal wire for supplying 5V power supply to the sync device from the source device. The sync device outputs a 5V HPD signal to the HPD pin of a HDMI terminal, when a 5V power supply from the source device is supplied from the fourth signal wire.

The fifth signal wire is a Consumer Electronics Control (CEC) signal wire used for realizing a CEC function.

The CEC function is a function that enables bidirectional control between a source device and a sync device and is specified in the HDMI standard as well as the format of AV data output. Currently, electronic devices accommodating the CEC function exist widely in the market. Since the CEC function realizes a command exchange between a source device and the sync device bi-directionally, either peer to peer device control, or one-to-many control are possible.

In the CEC standard, various functions are specified, for example, “One Touch Play” can be specified. In such a function, when a “Play” button of a source device, e.g., a DVD recorder, etc. is toggled, a sync device, e.g., a Digital Television, etc. automatically shifts from a standby-mode (which maintains a power-saving standby state) to a power-on mode (which maintains a normal operation state), then a HDMI terminal which is connected to the source device by a HDMI cable is selected as an “input”. In the CEC standard, many other functions are defined and each manufacture can select which function to install in the HDMI device.

Generally, the source device and the sync device, which are HDMI devices, are configured so that a setup of signal processing relating to image quality of the output image or sound quality of the output sound can be changed. Further, in order for a user to easily change such settings, some of the devices output image signals for displaying a menu screen for setting signal processing or displaying a menu screen.

However, in an AV system where the HDMI devices (source device and sync device) are connected by the HDMI cable, it is not easy for a user to set the quality of output image or sound.

For example, in the above-mentioned AV system, similar signal processing (such as noise reduction or gamma correction to an image data, or filtering to an audio data) can be executed in both a source and a sync device. Therefore, the quality of the AV system as a whole can be affected in a number of ways, for example, the when signal processing is executed in the source device only, the sync device only, or both the source and the sync device. However, it can be difficult to determine which device(s) may be best suited for improving the quality of an output image and/or the sound of the AV system as a whole.

This is because the signal processing characteristics of image or sound quality differ depending on the specific device (such as DTV (Digital Television), DVC (Digital Video Camera), or DVD recorder) in HDMI devices. Further, even in the same type of device, the characteristics can differ depending on the quality or grade of the device, i.e., high grade or low grade. Therefore it can be difficult for a user to recognize the signal processing characteristics of the source and sync devices.

Generally, higher priced HDMI devices have good signal processing performance. However, since characteristics may vary depending on devices, a user is simply unable to conclude that the mere use of a more costly HDMI device may be best.

The following is an example of an AV system wherein HDMI devices (DTV and DVC) are connected by a HDMI cable and the quality of output image and/or sound is deteriorated.

When a DVC stores an image data having MPEG or JPEG format in a media (such as SD card), the DVC generally executes noise reduction as a preprocessing step before transmitting the data to the DTV for the data reproduction. In addition, a DTV can also include a noise reduction function. Accordingly, when a noise reducing function is enabled in both the DVC and the DTV, a resolution of the image may be substantially low due to a superposition of the noise reduction processes. Further, a similar situation can occur relative to the gamma or contrast compensation and the image quality of the whole AV system may deteriorate when the settings of the DVC and DTV combine.

Further, when the data stored in a DVC is in SD format, it is possible to execute a scaling for converting the data to a high resolution format before transmitting the data to a DTV. When the scaling performance is superior in a DTV when compared to a DVC, it is preferable to perform scaling in the DTV. On the other hand, when the scaling performance is better in a DVC (for example when DTV is a compact sized TV) the quality of the output image may become poor when the scaling is executed in the DTV when compared to its execution in the DVC.

As for a sharpness processing, though it may be executed in a low resolution image, unless processing is performed after the scaling, the image quality of the output picture of the whole AV system can become low.

For sound data, when a DTV has a dedicated chip performing high quality audio processing, audio processing in DVC can interfere with the processing in DTV.

### SUMMARY OF THE INVENTION

A HDMI device comprises: a storing unit storing signal-processing characteristic information (data) relating to image and/or sound quality of the device, an information acquisition unit acquiring the signal-processing characteristic information of another device connected by an HDMI connection from the other device, and a setting changing unit changing the setting of signal-processing relating to the image and/or sound quality of the device based on the characteristic information (data) stored in the storing unit and the characteristic information (data) acquired by the information acquisition unit.

### BRIEF DESCRIPTION OF THE DRAWINGS

FIG. 1 is an illustration of an exemplary HDMI connection of a source device and a sync device.

FIG. 2 is an illustration of an exemplary functional block diagram of a digital television operatively connected with an HDMI device according to the instant disclosure;

FIG. 3 is an illustration of an exemplary functional block diagram of a digital video camera operatively connected with an HDMI device according to the instant disclosure;

FIG. 4 is an illustration of an exemplary procedure for changing a setup of signal processing of image quality of an output image and sound quality of an output sound.

### DETAILED DESCRIPTION OF THE INVENTION

An exemplary HDMI device or an electronic device including an exemplary HDMI device according to the instant disclosure will now be described in further detail with reference to the accompanying drawings.

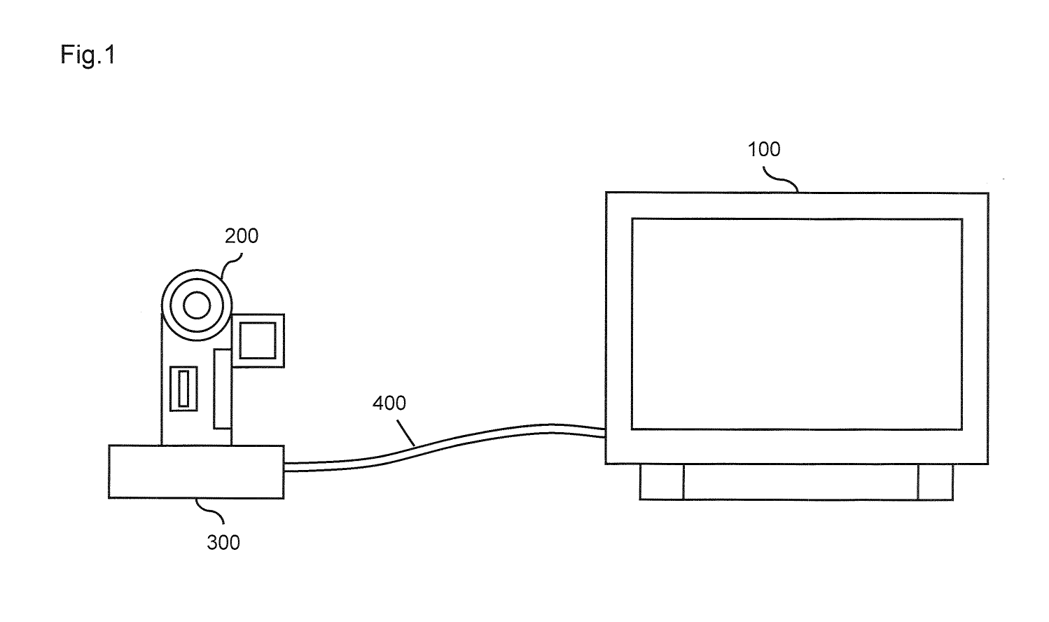

FIG. 1 illustrates an example of an HDMI connection between a source device and sync device. In the figure digital television (DTV) 100 is a sync device and digital video camera (DVC) 200 is a source device. DTV 100 and DVC 200 serve as examples of HDMI devices and/or electronic devices including an exemplary HDMI devices according to the instant disclosure.

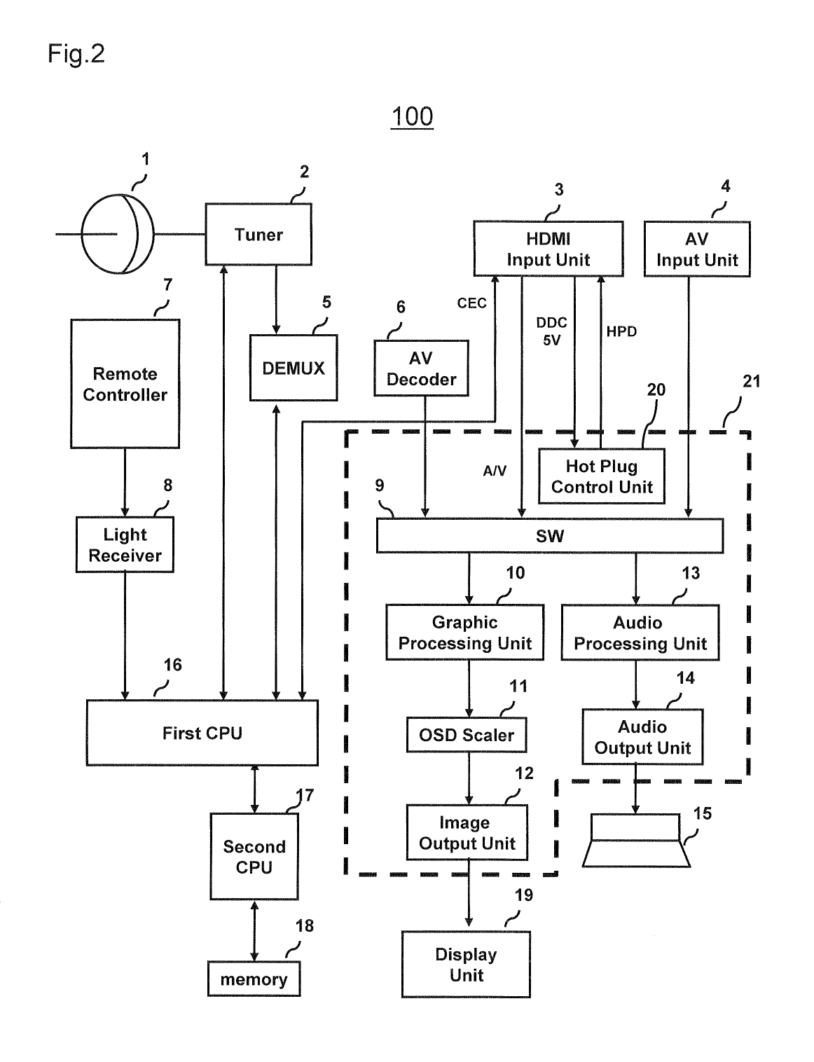

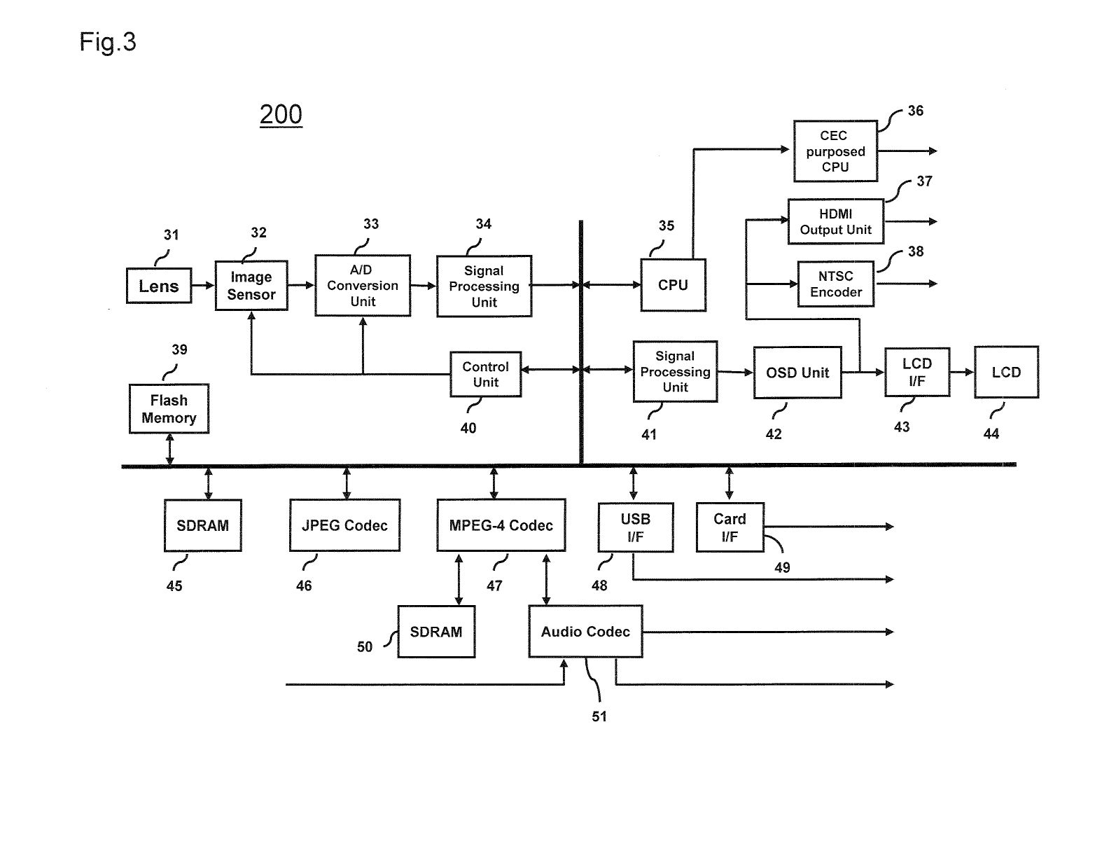

DTV 100 is connected with DVC 200 by HDMI cable 400 via power supply cradle 300. One end of HDMI cable 400 is connected to a HDMI terminal equipped in DTV 100. The other end of HDMI cable 400 is connected to a HDMI terminal equipped in cradle 300. When DVC 200 is put down to the cradle 300, connectors of DVC 200 and cradle 300 are connected. As a result, HDMI input unit 3 of DTV 100 (see FIG. 2) and HDMI output unit 37 of DVC 200 (see FIG. 3) are connected via cable 400 and cradle 300.

FIG. 2 illustrates an exemplary functional block diagram of a digital television (DTV). DTV 100 includes tuner 2, HDMI input unit 3, AV input unit 4, DEMUX (demultiplexer) 5, AV decoder 6, light receiving unit 8, switch 9, graphic processing unit 10, OSD (On Screen Display) scaler 11, image output unit 12, audio processing unit 13, audio output unit 14, speaker 15, first CPU (Central Processing Unit) 16, second CPU 17, memory 18, display unit 19, and hot plug control unit 20.

Antenna 1 can be arranged outdoor, receives a digital broadcasting wave and then outputs a high frequency digital modulated signal to tuner 2.

Tuner 2 chooses a physical channel based on a channel selection signal from first CPU 16. According to this selection process, tuner 2 converts a digital modulated signal having a high frequency to a signal having a specific frequency. Further, tuner 2 demodulates the selected modulated signal, generates a transport stream, and then outputs the generated transport stream to DEMUX 5.

DEMUX5 separates a transport stream received from tuner 2 into a video stream, an audio stream, and PSI/SI (Program Specific Information/Service Information) of MPEG-2 (Moving Picture Experts Group-2) system.

AV decoder 6 has a video decoder (not illustrated) decoding a video stream, and an audio decoder (not illustrated) decoding an audio stream. AV decoder 6 outputs the decoded audio and video information to switch 9.

HDMI input unit 3 has three HDMI terminals (not illustrated), and each of the terminals are connectable with the HDMI cable. The audio and video information inputted to HDMI input unit 3 from an external device via TMDS data signal line of the HDMI cable is inputted to switch 9.

Since CEC pins of each of the HDMI terminals are connected directly to first CPU 16, a CEC command inputted to HDMI input unit 3 from the external device (source device) via the CEC signal wire of the HDMI cable is inputted to first CPU 16.

The CEC commands outputted to HDMI input unit 3 from first CPU 16 is inputted to the external device (source device) via the CEC signal wire of the HDMI cable.

A 5V power supply is supplied to hot plug control unit 20 from an external device (source device) via a DDC5V signal wire of the HDMI cable and HDMI input unit 3.

NVRAM (not illustrated) is equipped for every HDMI terminal. A 5V power supply is supplied only to a NVRAM equipped for HDMI terminal where the HDMI cable is connected, from the source device via the DDC5V signal wire and the unit.

Hot plug control unit 20 directs the timing of send out start of AV data from a source device to a sync device by outputting a low-level or high-level control signal to HDMI input unit 3.

AV input unit 4 can include S terminal, D terminal, and RCA terminals (not illustrated). The audio and video information inputted to AV input unit 4 via an S terminal cable or a D terminal cable and an RCA terminal from an external device is outputted to switch 9.

Switch 9 is provided for switching audio or video information from AV decoder 6, HDMI input unit 3, or AV input unit 4. Graphic processing unit 10 executes digital image processing to a video signal input via switch 9. OSD scaler 11 is a circuit that generates image data based on text and color information directed from second CPU 17. Scaler 11 also reduces the size of the received broadcast images. Owing to OSD scaler 11, an EPG (Electronic Program Guide) based on program information, data-broadcasting, and menu screen can be displayed. Image output unit 12 converts image information transmitted from OSD scaler 11 to a signal having a format suitable for display unit 19. Display unit 19 displays an image based on the signal input from image output unit 12.

Audio processing unit 13 receives audio information via switch 9 and outputs an analog audio signal converted by D/A conversion to audio output unit 14. Audio output unit 14 amplifies an audio signal transmitted from audio processing unit 13 and outputs to speaker 15. Speaker 15 outputs a sound based on the audio signal from audio output unit 14.

Remote controller 7 is a transmitter for transmitting instructions to DTV 100. When a key provided on remote controller 7 is operated, the corresponding remote control signal is transmitted from a light emitting part of controller 7. Light receiving unit 8 receives a signal (in forms of light) from controller 7, converts the signal to an electric signal, and then outputs the converted signal to first CPU 16.

First CPU 16 performs a processing based on the signal from controller 7, or the inputted signal from an operation unit (not illustrated) of DTV 100. CPU 16 also controls tuner 2 as well. CPU 16 is kept operating in a power supplied state even when DTV 100 is instructed from remote controller 7 to power OFF (which is a “power save mode”) so that DTV 100 can observe the signal from controller 7. Second CPU 17 is provided to control OSD scaler 11, graphic processing unit 10, and display unit 19. CPUs 16 and 17 are designed so that they can communicate with each other. For example, CPU 16 can control the activation of CPU 17 or audio/video processing unit 21.

Memory 18 is nonvolatile memory and stores control programs or various data. Memory 18 also stores signal processing characteristics (data) regarding to IQ-SQ (Image Quality of the output image and Sound Quality of the output sound), and the settings of the signal processing. Graphic processing unit 10 and OSD scaler 11 execute signal processing of the image signal based on the settings stored in memory 18. The audio processing unit 13 and the audio output unit 14 execute signal processing of the audio signal based on the settings stored in the memory 18.

FIG. 3 illustrates an example of a functional block diagram of digital video camera (DVC) 200. The DVC 200 includes lens 31, image sensor 32 such as CCD (Charge Coupled Device) or CMOS (Complimentary Metal Oxide Semiconductor) sensor, A/D conversion unit 33, signal-processing unit 34, CPU 35, CEC purposed CPU 36, HDMI output unit 37, NTSC (National Television System Committee) encoder 38, flash memory 39, control unit 40, signal-processing unit 41, OSD unit 42, LCD (Liquid Crystal Display) interface 43, LCD 44, SDRAM (Synchronous Dynamic Random Access Memory)45, JPEG (Joint Photographic Experts Group) codec 46, MPEG-4 codec 47, USB (Universal Serial Bus) interface 48, card interface 49, SDRAM50, and audio codec 51. Signal processing unit 34, CPU 35, flash memory 39, control unit 40 and signal processing unit 41, SDRAM45, codecs 46 and 47, and interfaces 48 and 49 are connected to the bus respectively.

DVC 200 acquires an image data, which is an electric signal, by achieving a photoelectric conversion of the light entering through lens 31 in image sensor 32. The image data acquired by the image sensor 32 is converted to a digital signal from an analog signal by the A/D conversion unit 33, and is inputted to the signal-processing unit 34. Signal processing unit 34 performs various signal processing upon the image data from the unit 33, such as conversion to YCbCr format, a white balance adjustment, and a level adjustment. The image sensor 32 and the conversion unit 33 are controlled by control unit 40. On the other hand, the overall control of the DVC 200 is performed by CPU 35, and the activation of the control unit 40 is also controlled by CPU 35.

The image data outputted from signal-processing unit 34 is transmitted to MPEG4 codec 47 where the data is compressed to MPEG-4 format data, and then stored to SD card via card interface 49 when video recording. The image data is transmitted to JPEG codec 46 where the data is compressed to JPEG format data, and then stored to SD card via the interface 49 when still image recording.

When image reproducing, the card interface 49 read outs the image data from the SD card. When the image data is video, the data is decoded by MPEG-4 codec 47, and when it is still image, the data is decoded by JPEG codec 46. Then, various signal processing, such as scaling, image quality adjustment, and noise rejection, are executed by the signal-processing unit 41, then a text information for a menu screen displaying is added by the OSD unit 42, and is outputted to LCD 44 via LCD interface 43. Further, the image data outputted from the OSD unit 42 is converted to a NTSC signal by the NTSC encoder 38, and outputted to the external device via output terminals, such as S terminal or RCA terminal. The image data outputted from the OSD unit 42 is also converted to a TMDS format signal by HDMI output unit 37, and then is outputted to a sync device (DTV 100 in this embodiment) via HDMI terminal.

The CEC purposed CPU 36 for CEC performs a CEC communication processing according to a control from CPU 35. The CEC command generated by the CPU 36 is outputted to a sync device (DTV 100) via the HDMI terminal. The CEC command transmitted from the sync device (DTV 100) is inputted to the CPU 36 via HDMI terminal and is processed by the CPU 36.

In DVC 200, the audio codec 51 equipped with microphone amplifier and ALC (Auto Level Control) executes various signal processing (such as A/D conversion, amplification, level adjustment, and diversity adjustment) to the audio signal transmitted from a built-in microphone or an external microphone. The audio data outputted from the codec 51 is compressed to AAC (Advanced Audio Coding) format in MPEG 4 codec and is stored to SD card via card interface 49.

When audio reproducing, the card interface 49 read outs an audio data from SD card. The read out data is decoded by the MPEG-4 codec 47, then D/A converted by the audio codec 51 equipped with a speaker amplifier, and finally is outputted to a built-in speaker or an external speaker. The codec 51 also outputs the decoded audio data to the HDMI output unit 37.

DVC 200 also has a nonvolatile memory (not illustrated) for storing control programs and various data. The memory also stores signal processing characteristic information (data) relating to IQ-SQ, and the signal processing setting relating to IQ-SQ. The signal-processing unit 41 and the OSD unit 42 execute a processing to the image signal based on the setting stored in the memory. The audio codec 51 executes a processing to the audio signal based on the setting stored in the memory.

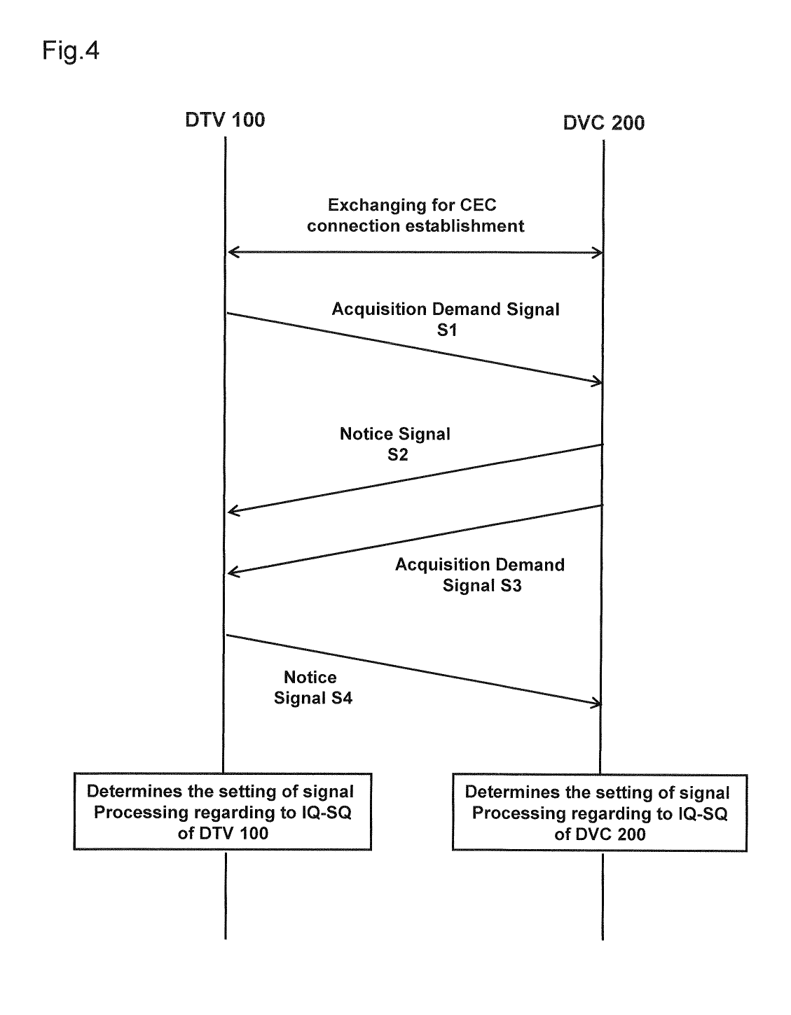

FIG. 4 is an exemplary illustration of a procedure for changing a setup of signal processing relating to IQ-SQ (image quality of an output image and sound quality of an output sound) when the procedure is performed in both DTV 100 and DVC 200.

When constructing an AV system with DTV 100 and DVC 200 using HDMI interface, first, DVC 200 is laid on the power supply cradle 300. Second, one end of the HDMI cable 400 is connected to a HDMI terminal equipped on DTV 100, and finally the other end of the cable 400 is connected to a HDMI terminal equipped on the cradle 300. Thereby, HDMI connection between DTV 100 and DVC 200 is made.

Thereafter, certain information is exchanged for CEC connection establishment between DVC 200 and DTV 100. The exchanging information can include, for example, HPD or HDCP authentications. However, depending on the source device, the HDCP authentication may be omitted.

Then, the DTV 100 transmits an acquisition demand signal S1 to DVC 200, where the S1 is a signal for demanding a signal processing characteristic information (data) relating to IQ-SQ of DVC 200. The signal S1 is a CEC command which is defined uniquely by a vender (a so called “vendor command”). Table 1 provides an example.

TABLE 1

| Data | Content | Example |
|---|---|---|
| 1st byte | Address | 0x04 |
| 2nd byte | OP_Code | 0x89 |
| 3rd byte | Inquiring a function | 0X11 |

A first byte data relates to Address. Here, it indicates communication from DTV 100 (whose logic address is 0) to DVC 200 (whose logic address is 4). The content of the Address changes depending on the direction of communication. For example, to indicate a communication from DVC 200 to DTV 100, the Address may be changed to “0×40” as shown below in Table 2. The second byte relates to OP_Code, which shows that the command is an original code designed by a vendor. The third byte shows that the command for inquiring a function to the communicating partner, for example an acquisition demand of the signal processing characteristic relating to IQ-SQ.

In response to the signal 51, DVC 200 transmits a notice signal S2 notifying its signal processing characteristic information relating to IQ-SQ to DTV 100. The signal S2 is a CEC command (as well as the signal S1). Table 2 provides an example.

TABLE 2

| Data | Content | Example |
|---|---|---|
| 1st byte | Address | 0x04 |
| 2nd byte | OP_Code | 0x89 |
| 3rd byte | Notifying a Function | 0x10 |
| 4th byte | Total Number of Functions | 0x02 |
| 5th byte | Function Number | 0x01 |
| 6th byte | Characteristic | 0x02 |
| 7th byte | Function Number | 0x04 |
| 8th byte | Characteristic | 0x01 |

The first byte relates to Address. Here it indicates communication from DVC 200 (whose logic address is 4) to DTV 100 (logic address 0). The second byte relates to OP_Code showing that a command is an original code of a vendor. The third byte shows a functional notice (noticing a signal processing characteristic regarding to IQ-SQ of its device). The fourth byte shows a total number of classifications transmitted regarding to audio and video signal-processing. The bytes subsequent to the fifth byte shows a function number (classification regarding to audio video signal-processing) and a number indicating characteristic (performance) of the function defined by the function number, in a unit of 2 bytes.

The example of classifications of audio/video signal-processing is as follows. Relative to image (video), it can be classified to luminosity of backlight (in case of LCD displays), contrast, brightness, color strength, sharpness, noise reduction, color temperature, skin color compensation, cinema auto, dynamic AI (Auto Image control), gamma correction, output resolution etc. Relative to sound (audio), it can be classified to loud sound, low-pitched sound, 3D surround, FOUCUS, woofer level etc.

After transmitting the signal S2, the DVC 200 transmits an acquisition demand signal S3 to DTV 100, demanding the signal processing characteristic information (data) relating to IQ-SQ of DTV 100. The signal S3 is a CEC command uniquely defined by a vender, and format can be defined as well as the signal S1.

Responding to the signal S3, DTV 100 transmits a notice signal S4 to DVC 200, notifying a signal processing characteristic (data) regarding to IQ-SQ of DTV 100. The signal S4 is a CEC command uniquely defined by the vender as well, and the format can be defined as well as the signal S2.

DTV 100 determines the setting of signal processing relating to IQ-SQ based on its signal processing characteristic information of IQ-SQ stored in memory 18 and the signal S2 from the DVC 200. Then DTV 100 changes the setting based on the determination. Similarly, DVC 200 determines the setting based on its characteristic information (data) stored in its internal non volatile memory and the signal S4 from DTV 100. Then DVC 200 changes the setting based on the determination. The determining method varies depending on a classification of signal-processing. For example, when using a noise filter, each DTV 100 and DVC 200 determines the setting, so that only one of the noise filters having a good quality is effective.

The setting determined by the above-mentioned method should be placed back to the original setting when the HDMI connection is canceled. Or, instead, the setting may be stored to a memory un-volatility before placing it back to the original, when the HDMI connection is canceled. Then, the setting may be read out from the memory when the HDMI connection is regenerated.

The procedure described in FIG. 4 is an exemplary case when both DTV 100 and DVC 200 support communication acquiring the demand signal and the notice signal. On the other hand, if DTV 100 supports the above communication while DVC 200 does not support, it can be recognized so from a fact that DVC 200 did not transmit the notice signal S2 even though DTV 100 transmit the acquisition demand signal S1.

According to the procedure explained in FIG. 4, both DTV 100 and DVC 200 determined the setup of signal processing regarding to IQ-SQ of their device. However, only one of them may determine the setting. In such case, the communication of the signal S3 and S4 should be omitted, and DTV 100 may determine the setting of DTV 100 and DVC 200 based on signal processing characteristic (data) relating to IQ-SQ of DTV 100 stored in the memory 18 and the signal S2, and may notify the setting information to DVC 200 using a CEC command.

The invention is not limited to the foregoing embodiments but can be modified variously by one skilled in the art without departing from the spirit and scope of the invention as set forth in the appended claims. For example, by preparing an HDMI terminal in DVC 200, DTV 100 and DVC 200 may be connected by HDMI cable 400 directly without going through the power supply cradle 300.

What is claimed is:

1. An HDMI device comprising:
a storage unit for storing signal processing performance data relating to at least one of image quality of an output image and sound quality of an output sound of the HDMI device;
an information acquisition unit acquiring signal processing performance data relating to at least one of image quality of an output image and sound quality of an output sound of a connecting device by reception of a CEC command; and,
a setting changing unit determining a signal processing setting relating to the image quality of the output image and the sound quality of the output sound of the HDMI device, the signal processing setting based on the signal processing performance data stored in the storage unit and the signal processing performance data acquired by the information acquisition unit, the setting changing unit modifying the signal processing setting according to the determining.

2. The HDMI device of claim 1, wherein
the information acquisition unit requests signal processing performance data of the connecting device by transmission of a CEC command.

3. The HDMI device of claim 1, wherein
the setting changing unit further determines a signal processing setting relating to the image quality of the output image and the sound quality of the output sound of the connecting device, the signal processing setting based on the signal processing performance data stored in the storage unit and the signal processing performance data acquired by the information acquisition unit, the setting changing unit modifying the signal processing setting according to the determination; and
the HDMI device further comprises:
a setting notifying unit transmitting the signal processing setting to the connecting device via a CEC command.

4. A HDMI device comprising:
a storing unit storing signal-processing data relating to at least one of image and sound quality of the HDMI device;
an information acquisition unit acquiring signal-processing data of an other device connected by an HDMI connection to the HDMI device, and
a setting changing unit changing a setting of signal-processing relating to one of the image or sound quality of the HDMI device based on the signal-processing data stored in the storing unit and the signal-processing data acquired by the information acquisition unit.

5. The HDMI device of claim 4, wherein
the information acquisition unit acquires the signal-processing data from the other device using a CEC command.

6. The HDMI device of claim 4, wherein
the setting changing unit further determines the setting of signal processing relating to one of image or sound quality of the other device based on the signal-processing data stored in the storing unit and the signal-processing data acquired by the information acquisition unit; and
the HDMI device further comprises a notice unit notifying a setting, determined by the setting changing unit, to the other device using a CEC command.

7. The HDMI device of claim 4, wherein
the information acquisition unit acquires the signal-processing data from the other device using a CEC command.

8. An electronic device comprising:
a storing unit storing signal-processing information relating to at least one of image quality of an output image and sound quality of an output sound of the electronic device;
an information acquisition unit acquiring signal-processing information of an other device from the other device; and,
a setting changing unit changing a setting of signal processing relating to the image or sound quality of the electronic device based on the signal-processing information stored in the storing unit and the signal-processing information acquired by the information acquisition unit.
